(19) United States
(12) Patent Application Publication
(10) Pub. No.: US 2015/0047625 A1
(43) Pub. Date: Feb. 19, 2015

(54) BARBECUE GRILL

(71) Applicant: FRED WEIL, CHARLESTON, SC (US)

(72) Inventor: FRED WEIL, CHARLESTON, SC (US)

(21) Appl. No.: 13/966,162

(22) Filed: Aug. 13, 2013

(51) Int. Cl. A47J 37/07

(52) U.S. Cl. CPC A47J 37/0713; A47J 37/0786
USPC 126/25 A

(57) ABSTRACT

The barbecue grill is configured to use fluid fuel (e.g., propane), solid fuel (e.g., charcoal or wood), or both. Two solid fuel support grates are provided above a pair of gas burners, so that the gas flame can be used to ignite the solid fuel above the burners. The two solid fuel grates are relatively movable to shake down burned ash into a collection tray below the gas burners. Two flame control grates are installed above the solid fuel grates. The spacing between the flame control grates is adjustable to control the amount of flame and heat passing to the overlying vertically adjustable cooking rack. The two flame control grates are configured to allow liquid fat and juices to run between the members of the upper grate and into corresponding spaced apart channels in the lower grate, where they run off to be collected in a container for disposal.

### BACKGROUND OF THE INVENTION

1. Field of the Invention

The present invention relates generally to the field of cooking and food preparation, and particularly to a barbecue or cooking grill having various adjustable racks, grills, and grates therein to control the cooking process.

2. Description of the Related Art

The transfer of the cooking process from outdoors to indoors has occurred as technology has advanced to enable cooking to take place safely in an indoor kitchen or the like. However, there has been a movement on the part of many people to cook outdoors as a change of pace from what has become standard or conventional indoor cooking practice. Many people also prefer the flavor that may be imparted to foods cooked over various solid fuels, such as wood and charcoal. These flavors are not readily attainable when the foods are cooked indoors using modern appliances.

As a result, a great many different outdoor barbecue or cooking grills or appliances have been developed in the past. These devices generally include some form of fire pit or fire box and a food cooking grill above the pit to support the food as it is being cooked. More sophisticated barbecues will provide some form of height adjustment for the cooking grill above the fire pit, and/or various other features to facilitate the cooking process and/or to enhance the flavor of the cooked foods.

A chronic problem with meats being cooked over a fire upon an open grill is the release of liquid fats and juices. In conventional grills, these fats and juices drip into the fire or coals beneath and produce flare-ups of the fire and inconsistent cooking. Moreover, the residue from such fats and juices tends to bake onto the cooking grill and onto the surface of the underlying fire pit. The resulting baked on solids are generally extremely difficult to remove.

Thus, a barbecue grill solving the aforementioned problems is desired.

### SUMMARY OF THE INVENTION

The barbecue grill is configured to enable the user to cook with either fluid or solid fuel, or both, as desired. The gaseous fuel may be propane or other suitable combustible gas. The solid fuel may be charcoal, wood, or other suitable combustible solid. The solid fuel is placed upon the upper grate of a pair of grates, which are relatively movable to shake down burned ashes and other residue into an ash catching drawer or tray therebelow. Two fluid fuel burner elements extend across the grill below the solid fuel support grates and above the bottom of the ash capture tray. Thus, the fluid fuel from the burner elements may be ignited to ignite the solid fuel on the grates above the burner elements, or the fluid fuel alone may be used for cooking when no solid fuel is provided.

Two flame control grates are installed above the solid fuel support grates. One of the flame control grates is immovably affixed in the barbecue grill structure, and the other is vertically adjustable relative to the fixed flame control grate. The vertical spacing between the two flame control grates is adjustable to control the level of the flame and the amount of heat passing through the two grates to the overlying vertically adjustable cooking grill or rack. The uppermost of the two flame control grates comprises a plurality of spaced apart parallel members, each having a generally V-shaped cross section. The members or channels of the upper flame control grate may be upright or inverted. The lower flame control grate comprises a corresponding plurality of spaced apart parallel channels, each having an upright, generally V-shaped cross section. Other cross sections may be used, e.g., U-shape, etc., so long as the cross section forms a channel. The spaces between the members of the upper grate are positioned above the channels of the lower grate. In this manner, liquids released from foods being cooked on the cooking grill will drip onto the members of the upper flame control grate and run into the channels of the lower flame control grate, where they run off for collection in a container for later disposal.

These and other features of the present invention will become readily apparent upon further review of the following specification and drawings.

### BRIEF DESCRIPTION OF THE DRAWINGS

FIG. 1 is a perspective view of a barbecue grill according to the present invention, illustrating its various features.

FIG. 2 is an elevation view of the barbecue grill of FIG. 1, illustrating the relationships between the major components thereof.

FIG. 3 is a partial perspective view of the flame control and grease collection channels of the barbecue grill of FIG. 1, illustrating further details thereof.

Similar reference characters denote corresponding features consistently throughout the attached drawings.

### DETAILED DESCRIPTION OF THE PREFERRED EMBODIMENTS

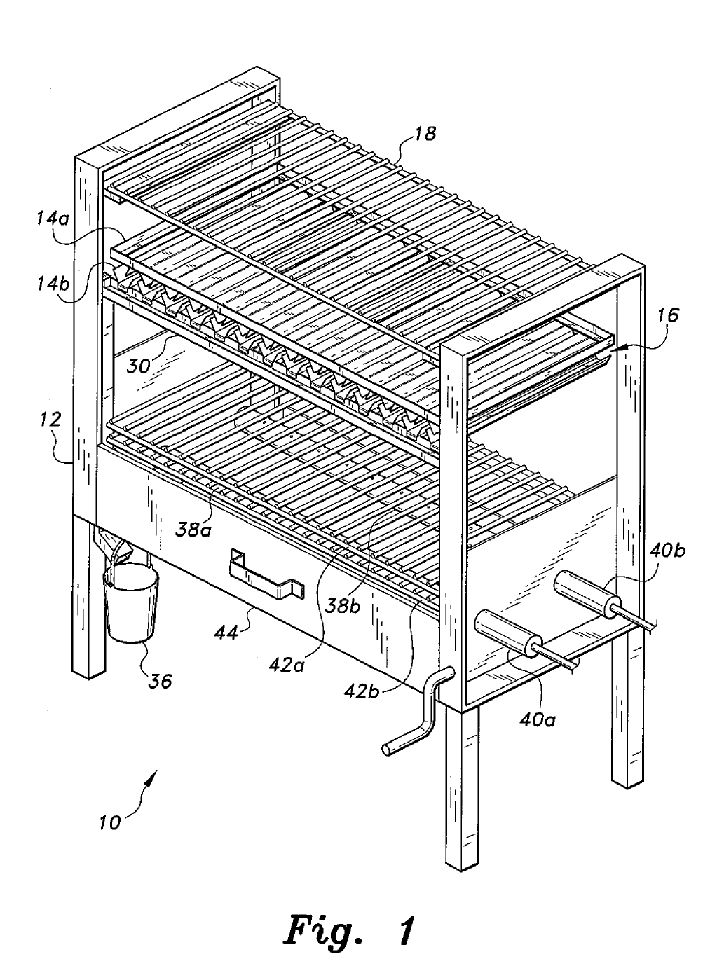

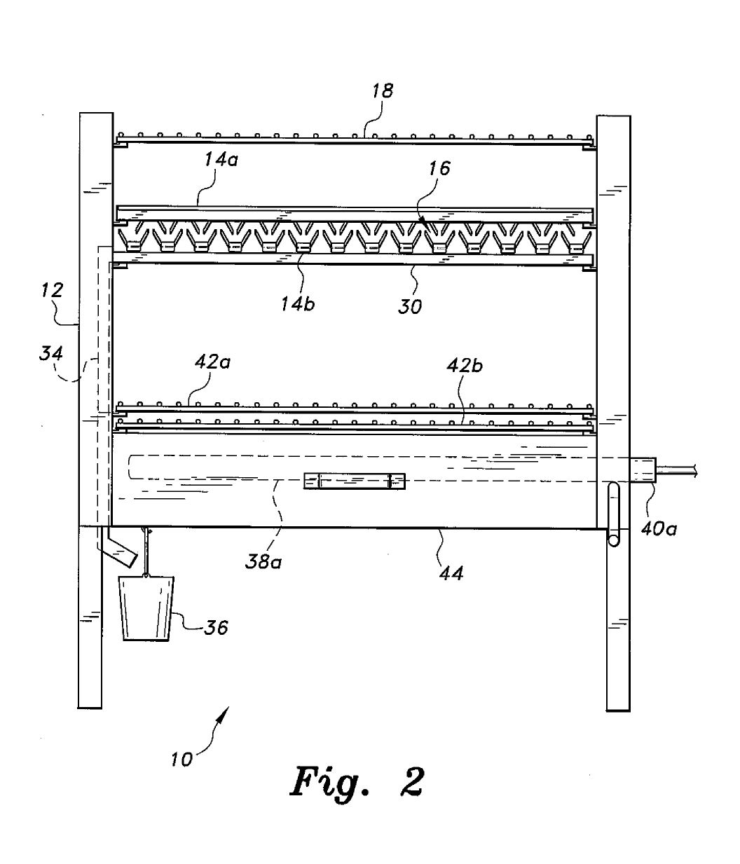

The barbecue grill incorporates a number of features that provide versatility and consistency in cooking and ease of cleanup after a barbecuing or cooking session using the grill. FIGS. 1 and 2 provide perspective and front elevation views, respectively, of the barbecue grill 10, illustrating its basic features. The barbecue grill 10 includes a support structure 12 comprising a frame or the like for the attachment and support of the various components of the grill 10. The support structure 12 may include a plurality of legs, as shown, or other structure to support the other grill components at a convenient height. The legs or other structure may have wheels for portability.

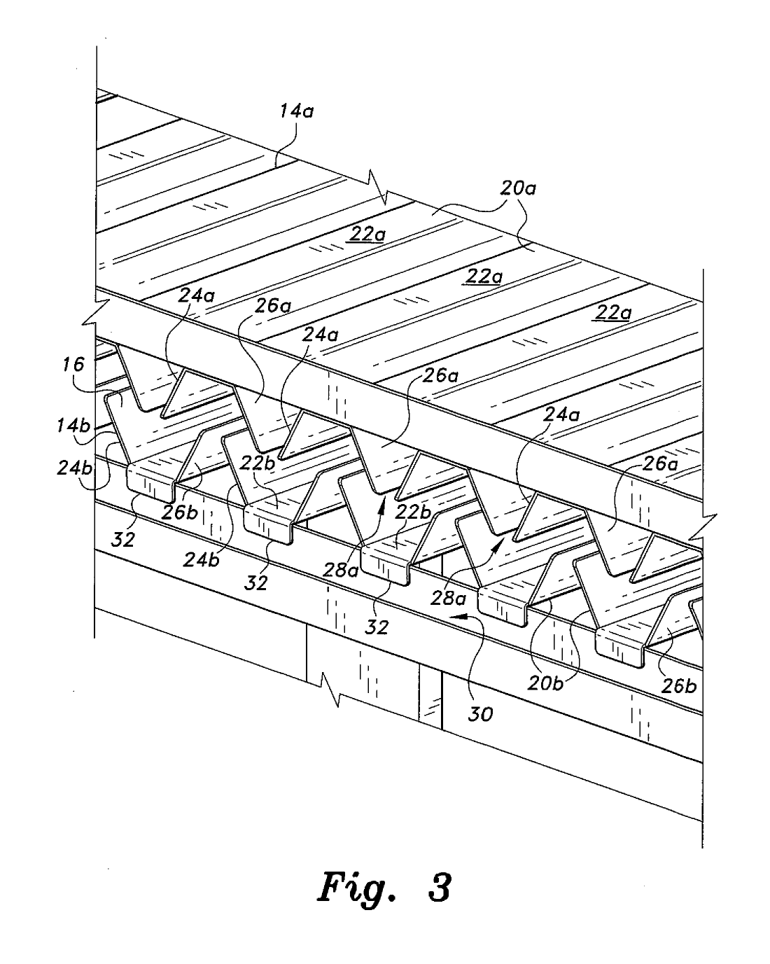

Upper and lower flame control grates 14a, 14b are installed across the support structure or frame 12. A detail of these flame control grates 14a and 14b is shown in FIG. 3 of the drawings. The two flame control grates 14a and 14b are generally fixed in the support structure or frame 12, but at least one of the grates is adjustable relative to the other, i.e., the upper grate 14a may be adjusted relative to the stationary lower grate 14b, or the lower grate 14b may be adjusted relative to the stationary upper grate 14a. The adjustment means is conventional, e.g., crank and levers, extended pins for selective placement in various notches or passages, etc. The two flame control grates 14a, 14b define a variable flame control gap 16 therebetween. The adjustable flame control gap 16 controls the amount of direct flame and heat that rises from the underlying fuel to cook or heat food placed upon the food support rack or cooking grill 18, which is supported on the frame above and spaced apart from the upper flame control grate 14a. The food support rack 18 is preferably vertically adjustable within the support structure 12 relative to at least the upper flame control grate 14a. The food support rack 18 adjustment means is conventional, e.g., extended pins and corresponding slots in the support structure 12, etc.

The two flame control grates 14a and 14b are configured similar to one another, but are inverted relative to one another in a first embodiment. The upper flame control grate 14a comprises a plurality of parallel, spaced apart inverted channels 20a, each of the channels having an inverted, generally V-shaped cross section that is formed with a flattened medial portion 22a and mutually opposed flanges 24a, 26a extending downward and outward from the lateral edges of the medial portion 22a. Other cross-sectional shapes, e.g., U-sections, etc., may be used, so long as the shape forms a channel. Any liquid fats, oils, juices, etc. that fall from the overlying food support rack 18 will fall upon the medial portions 22a or flanges 24a, 26a of the inverted channels 20a and fall through the drainage gaps 28a therebetween. An alternative embodiment may have the members or channels of the upper flame control grate in an upright orientation, i.e., with their outer flanges oriented upward. Such an alternative is disclosed in U.S. Pat. No. 5,363,752 to Fred Weil, which patent is incorporated herein in its entirety (see particularly FIG. 2 and col. 4, lines 45-48).

The lower flame control grate 14b is configured similar to the upper flame control grate 14a, but is inverted relative to the upper grate, as noted further above. The lower flame control grate 14b comprises a plurality of parallel, spaced apart upright channels 20b, each of the channels having a generally V-shaped cross section that is formed with a flattened medial portion 22b and mutually opposed flanges 24b, 26b extending upward and outward from the lateral edges of the medial portion 22b. As in the case of the upper flame control grate 14a, the channels may have other than V-shaped cross sections. It will be noted that the upper and lower channels 20a and 20b are staggered relative to one another, i.e., the drainage gaps 28a of the upper channels 20a directly overlie the medial portions 22b of the lower channels 20b, so that liquids fall through the drainage gaps 28a into the lower channels 20b.

The lower flame control grate 14b is preferably slightly sloped toward a liquid collection channel 30, so that liquids flow along the lower channels 20b and into the collection channel 30. Each of the ends of the lower channels 20b adjacent to the collection channel 30 has a drip lip 32 extending from the medial portion 22b and extending into the collection channel 30 to preclude liquid grease, oil, juices, etc. from flowing around the ends of the lower channels 20b and running back along the undersides of the channels 20b. The collection channel 30 is preferably slightly sloped to the left side in FIGS. 1 and 2, so that liquids collected in the collection channel 30 run to the left end thereof, where they drain down a tube or passage 34 (shown in broken lines in FIG. 2) in the support structure 12 to a collection container 36 for convenient disposal.

The adjustability of the two flame control grates 14a and 14b relative to one another, along with the adjustability of the cooking grill or food support rack 18, permits the user of the grill 10 to adjust the cooking process to a fine degree. For example, in many instances a cook may wish to sear the surface of a cut of meat while also cooking the meat through. The adjustability of the barbecue grill permits the cook to accomplish this and adjust the result to a fine degree. Initially, the cook may place the cut of meat (or other food to be cooked) on the food support rack or grill 18, and then open the flame control gap 16 between the two grates 14a and 14b to allow the flame to rise between and above the grates 14a, 14b to sear the undersurface of the food being cooked on the support rack 18. When one surface of the food has been seared to the desired degree, the food is turned over and the opposite side seared in the same manner. When the surface searing has been accomplished as desired, the cook may close the gap 16 between the two flame control grates 14a and 14b to reduce the amount of flame passing therethrough, and also to control the heat passing through the two grates 14a and 14b. Further control of the heat is accomplished by adjusting the height of the food support grill or rack 18 above the upper flame control grate 14a, as the heat is diffused with greater distance between the underlying upper flame control grate 14a and the cooking grill or rack 18. Accordingly, a steak or other food may be cooked precisely to the taste of the recipient by adjusting the various grills and grates as described above.

The barbecue grill 10 is capable of burning either fluid fuels or solid fuels to produce the heat required for cooking. Two gas burners 38a, 38b are installed across the support structure 12 in the lower portion thereof. Each of the gas burners preferably comprises an elongate tube extending substantially across the support structure, as shown particularly in FIG. 1 of the drawings, the tubes being substantially parallel to one another. The fluid fuel used may be propane or other suitable fuel. Pressure regulation may be provided by regulators 40a, 40b.

Cooking by means of solid fuel is provided by a solid fuel support grate assembly extending across the support structure 12, immediately above the gas burners 28a and 38b and below the flame control grates 14a and 14b and the food support rack 18 thereabove. While the solid fuel support grate assembly may comprise only a single grate, preferably two such grates 42a, 42b are provided. The two grates 42a, 42b are immediately adjacent to one another, as shown in FIGS. 1 and 2. The two grates 42a and 42b are movable relative to one another, i.e., the first grate 42a may be movable while the second grate 42b is fixed in the support structure 12, or the first grate 42a may be fixed while the second grate 42b is movable. The provision of two relatively movable solid fuel support grates 42a and 42b allows ash and other residue to be shaken down between the two grates 42a, 42b as they are moved. The ash and residue drops down between the two grates 42a, 42b to fall into the underlying ash collection drawer or tray 44 extending across the support structure 12 below the grates 42a and 42b and the two fluid fuel burners 38a and 38b.

It will be seen that the above-described configuration allows the barbecue grill 10 to be used with fluid fuel, solid fuel, or both, as desired. Merely omitting the placement of solid fuel on the fuel support grates 42a and 42b allows the user to connect a source of fluid fuel (e.g., propane) to the two regulators 40a and 40b and ignite the fluid fuel to cook using solely such fluid fuel in order to avoid the accumulation of solid ash and residue from solid fuel.

Alternatively, the user of the barbecue grill 10 may wish to use a solid fuel, such as wood or charcoal. In such a case, the user need not provide a supply of fluid fuel. The user need only place a sufficient supply of solid fuel on the support grates 42a and 42b, and ignite the solid fuel to produce heat for cooking. With either solid or fluid fuel, the amount of flame and heat passing through the flame control grates 14a and 14b is readily controlled by adjusting the flame control gap 16 therebetween to control the cooking process. Additional control of the cooking heat is provided by the vertically adjustable food support rack 18.

Another alternative allows the user to connect a source of fluid fuel to the regulators 40a and 40b, and also to place a sufficient quantity of solid fuel on the support grates 42a and 42b. The fluid fuel may be ignited to, in turn, ignite the solid fuel without undue effort or the need for other starting fluids and the like. The fluid fuel may be turned off once the solid fuel has ignited, if the user desires. When cooking with solid fuel has been completed, the conventionally removable (e.g., slide-out, etc.) ash collection drawer or tray 44 may be removed for emptying and cleaning. The drainage of any liquids and juices from the food being cooked by means of the flame control grates 14a, 14b, the liquid collection channel 30, the drain tube or passage 34, and the collection container 36 assures that no liquid residue will drip into any solid fuel residue in the collection tray 44 or onto the burners 38a and 38b, thus greatly facilitating cleanup of the barbecue grill 10 after use.

It is to be understood that the present invention is not limited to the embodiments described above, but encompasses any and all embodiments within the scope of the following claims.

I claim:

1. A barbecue grill, comprising:
a support structure;
an upper flame control grate disposed across the support structure;
a lower flame control grate disposed across the support structure, the upper and lower flame control grates defining a flame control gap therebetween, the upper and lower flame control grates and the flame control gap being height adjustable relative to one another; and
a food support rack disposed across the support structure above the flame control grates and spaced apart therefrom, the food support rack being vertically adjustable relative to the flame control grates.

2. The barbecue grill according to claim 1, further comprising:
first and second gas burners disposed across the support structure beneath the flame control grates; and
at least one solid fuel support grate disposed across the support structure between the gas burners and the flame control grates, the food support rack being disposed above the solid fuel support grate and spaced apart therefrom, the food support rack being vertically adjustable relative to the solid fuel support grate.

3. The barbecue grill according to claim 2, wherein each of the gas burners comprises an elongate tube extending substantially across the support structure, the tubes being substantially parallel to one another.

4. The barbecue grill according to claim 1, further comprising:
a first solid fuel support grate disposed across the support structure below the food support rack;
a second solid fuel support grate disposed across the support structure immediately adjacent to the first solid fuel support grate and below the food support rack, the first and second solid fuel support grates being movable relative to one another for shaking solid fuel residue therethrough; and
an ash collection tray disposed across the support structure beneath the first and second solid fuel support grates.

5. The barbecue grill according to claim 1, wherein:
the upper flame control grate comprises a plurality of parallel, spaced apart channels, adjacent ones of the channels defining a drainage gap therebetween; and
the lower flame control grate comprises a plurality of parallel, spaced apart upright channels, each of the channels having a medial portion, the medial portion of each of the channels of the lower flame control grate underlying a corresponding drainage gap of the channels of the upper flame control grate.

6. The barbecue grill according to claim 5, further comprising a drip lip extending from the medial portion of each of the channels of the lower flame control grate.

7. A barbecue grill, comprising:
a support structure;
first and second gas burners disposed across the support structure;
at least one solid fuel support grate disposed across the support structure above the gas burners; and
a food support rack disposed across the support structure above the solid fuel support grate and spaced apart therefrom, the food support rack being vertically adjustable relative to the solid fuel support grate.

8. The barbecue grill according to claim 7, further comprising:
an upper flame control grate disposed across the support structure between the solid fuel support grate and the food support rack; and
a lower flame control grate disposed across the support structure between the solid fuel support grate and the food support rack, the upper and lower flame control grates defining a flame control gap therebetween, the upper and lower flame control grates and the flame control gap being adjustable relative to one another, the food support rack being vertically adjustable relative to the flame control grates.

9. The barbecue grill according to claim 8, wherein:
the upper flame control grate comprises a plurality of parallel, spaced apart channels, adjacent ones of the channels defining a drainage gap therebetween; and
the lower flame control grate comprises a plurality of parallel, spaced apart channels, each of the channels having a medial portion, the medial portion of each of the channels of the lower flame control grate underlying a corresponding drainage gap of the channels of the upper flame control grate.

10. The barbecue grill according to claim 9, further comprising a drip lip extending from the medial portion of each of the channels of the lower flame control grate.

11. The barbecue grill according to claim 7, further comprising:
a first solid fuel support grate disposed across the support structure below the food support rack;
a second solid fuel support grate disposed across the support structure immediately adjacent to the first solid fuel support grate and below the food support rack, the first and second solid fuel support grates being movable relative to one another for shaking solid fuel residue therethrough; and
an ash collection tray disposed across the support structure beneath the first and second solid fuel support grates.

12. The barbecue grill according to claim 7, wherein each of the gas burners comprises an elongate tube extending substantially across the support structure, the tubes being substantially parallel to one another.

13. A barbecue grill, comprising:
a support structure;
a vertically adjustable food support rack disposed across the support structure;
a first solid fuel support grate disposed across the support structure below the food support rack;
a second solid fuel support grate disposed across the support structure immediately adjacent to the first solid fuel support grate, the first and second solid fuel support grates being movable relative to one another for shaking solid fuel residue therethrough; and
an ash collection tray disposed across the support structure beneath the first and second solid fuel support grates.

14. The barbecue grill according to claim 13, further comprising:
an upper flame control grate disposed across the support structure between the solid fuel support grates and the food support rack; and
a lower flame control grate disposed across the support structure between the solid fuel support grates and the food support rack, the upper and lower flame control grates defining a flame control gap therebetween, the upper and lower flame control grates and the flame control gap being adjustable relative to one another, the food support rack being vertically adjustable relative to the flame control grates.

15. The barbecue grill according to claim 14, wherein:
the upper flame control grate comprises a plurality of parallel, spaced apart channels, adjacent ones of the channels defining a drainage gap therebetween; and
the lower flame control grate comprises a plurality of parallel, spaced apart channels, each of the channels having a medial portion, the medial portion of each of the channels of the lower flame control grate underlying a corresponding drainage gap of the channels of the upper flame control grate.

16. The barbecue grill according to claim 15, further comprising a drip lip extending from the medial portion of each of the channels of the lower flame control grate.

17. The barbecue grill according to claim 13, further comprising first and second gas burners disposed across the support structure beneath the solid fuel support grates, the food support rack being vertically adjustable relative to the gas burners.

18. The barbecue grill according to claim 17, wherein each of the gas burners comprises an elongate tube extending substantially across the support structure, the tubes being substantially parallel to one another.
